(19) United States
(12) Patent Application Publication
(10) Pub. No.: US 2025/0382049 A1
(43) Pub. Date: Dec. 18, 2025

(54) Safety and Stability Device for an Aircraft

(71) Applicant: Aeroluxury LLC, West Plains, MO (US)

(72) Inventor: Douglas Dwayne Stroud, West Plains, MO (US)

(21) Appl. No.: 19/304,083

(22) Filed: Aug. 19, 2025

Related U.S. Application Data
(63) Continuation-in-part of application No. 18/506,466, filed on Nov. 10, 2023, now Pat. No. 12,409,930.
Application No. 18/506,466 is a continuation of application No. 17/815,483, filed on Jul. 27, 2022, now Pat. No. 11,851,161.

(51) Int. Cl. B64C 17/06

(52) U.S. Cl. CPC B64C 17/06

(57) ABSTRACT

Systems and methods for a gyroscopic rotational wing for an aircraft are disclosed. In one embodiment, a safety and stability device for an aircraft comprises an inner ring, an outer ring that rotates relative to the inner ring, and a motor connected to the inner ring that drives rotation of the outer ring relative to the inner ring. In some embodiments, the safety and stability device rotates in a substantially horizontal plane and at a rotational speed sufficient to provide gyroscopic stability for the aircraft.

### CROSS-REFERENCE TO RELATED APPLICATIONS

This application is a continuation-in-part of U.S. patent application Ser. No. 18/506,466 filed Nov. 10, 2023, which is a continuation of U.S. patent application Ser. No. 17/815,483 filed Jul. 27, 2022, now U.S. Pat. No. 11,851,161. The entire disclosures of the above applications are incorporated by reference.

### FIELD

The present disclosure relates to flying aircrafts and more particularly to systems and methods for using a spinning gyroscopic wing for aviation purposes.

### BACKGROUND

Air travel is a common mode of transportation. However, commercial air travel can be uncomfortable, expensive, and inconvenient given the rigorous regulation on the airline industry and the relatively limited availability of flights between some locations. Additionally, aircrafts are operated by a limited number of people who qualify as licensed pilots because the learning curve to fly an aircraft is extremely steep, for example, steeper than driving an automobile. Still, air travel is an effective mode of travel because air travel typically represents the shortest path between Point A and Point B and because air travel can safely occur at much higher speeds than other modes of transportation (e.g., automobiles, rail, or walking).

While airline travel has increased the mobility of humans, better travel options are still desired. For example, a commercial flight may effectively fly a human thousands of miles, but the places where aircrafts can land is relatively limited. Indeed, not all travel destinations have a commercial airport, and even in towns that have an airport, the airport may not be located particularly close to a person's ultimate destination. Additionally, conventional air travel is typically limited to long-distance travel because air travel is not efficient or feasible for shorter distance travel.

In view of the above, there is a continuing, ongoing need for improved air travel systems and methods.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### BRIEF DESCRIPTION OF THE DRAWINGS

The present disclosure will become more fully understood from the detailed description and the accompanying drawings.

FIGS. 1-4 illustrate a safety and stability device for an aircraft, according to an exemplary embodiment.

FIGS. 5 and 6 illustrate internal mechanisms for the safety and stability device, according to an exemplary embodiment.

FIG. 7 illustrates an aircraft implementing the safety and stability device, according to an exemplary embodiment.

FIGS. 8 and 9 illustrate components for connecting a fuselage and other compartments to the safety and stability device, according to an exemplary embodiment.

FIGS. 10A, 10B, and 10C illustrate a first frame for an aircraft, according to exemplary embodiments.

FIGS. 11A, 11B, and 11C illustrate another frame for an aircraft, according to exemplary embodiments.

FIGS. 12 and 13 illustrate components for connecting a fuselage and other compartments to a frame of an aircraft, according to an exemplary embodiment.

In the drawings, reference numbers may be reused to identify similar and/or identical elements.

### DETAILED DESCRIPTION

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Embodiments disclosed herein can include a safety and stability device used in aerospace or aviation. More particularly, the embodiments disclosed herein can include a safety and stability device rotating around a fuselage of an aircraft. The safety and stability device can rotate substantially horizontal to the ground while the aircraft is airborne. The safety and stability device can spin at a particular rate of speed such that the safety and stability device can operate as a gyroscope keeping the aircraft steady and level. Moreover, the safety and stability device can spin for aerodynamic purposes to cut through the air and decrease forward drag on the aircraft fuselage as the aircraft accelerates forward. In addition, the safety and stability device can protect the fuselage and cockpit from damage, such as if the aircraft were to hit a structure, such as buildings, trees, bridges, poles, or any other obstacle.

Due to the benefits described above, the safety and stability device described herein can allow for a personal aircraft or drone to be flown safely by more operators. The safety and stability device increases safety and also provides flight stability that will decrease the learning curve necessary for one to become an effective operator of the aircraft having the safety and stability device described herein. In one embodiment, a drone having the safety and stability device described herein can fly more safely and more stable than conventional drones. In another embodiment described herein, a personal aircraft having the safety and stability device described herein can allow for more air travel, even across shorter distances where conventional air travel would not have been efficient or feasible.

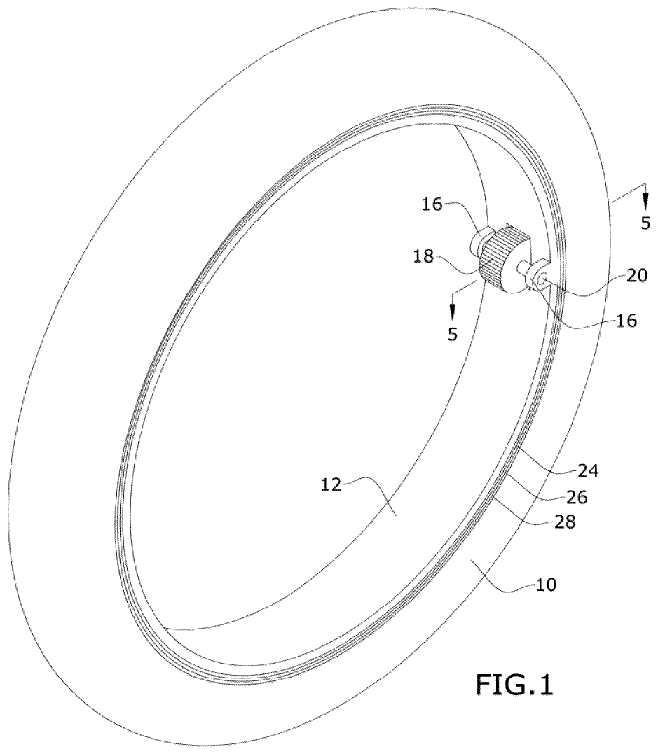

FIG. 1 illustrates a safety and stability device 100 according to an exemplary embodiment. The safety and stability device 100 can include an inner ring 12 and an outer ring 10 that rotates relative to the inner ring 12. The inner ring 12 may operate as a hub, and the inner ring 12 may connect to the outer ring 14 via a plurality of bearings 24, 26, 28, which can assist with the rotation of the outer ring 14. The safety and stability device 100 can include multiple bearings to meet redundancy requirements for flight set by aviation regulatory bodies, such as the Federal Aviation Administration (FAA). In the embodiment shown in FIGS. 1-6, the safety and stability device 100 can include three bearings, but more bearings can be included. Additionally, a safety and stability device 100 having a single bearing or two bearings is envisioned, should aviation regulations change. The plurality of bearings 24, 26, 28 may be ball, roller, or plain bearings, but in a preferred embodiment, the bearings are plain bearings. In any embodiment, the plurality of bearings 24, 26, 28 can decrease the friction between the outer ring 14 and the inner ring 12 when the outer ring 14 rotates relative to the inner ring 12. The inner ring 12 may include a spool with two grooves, and the bearings 24, 26, 28 and the outer ring 14 may ride within the groove.

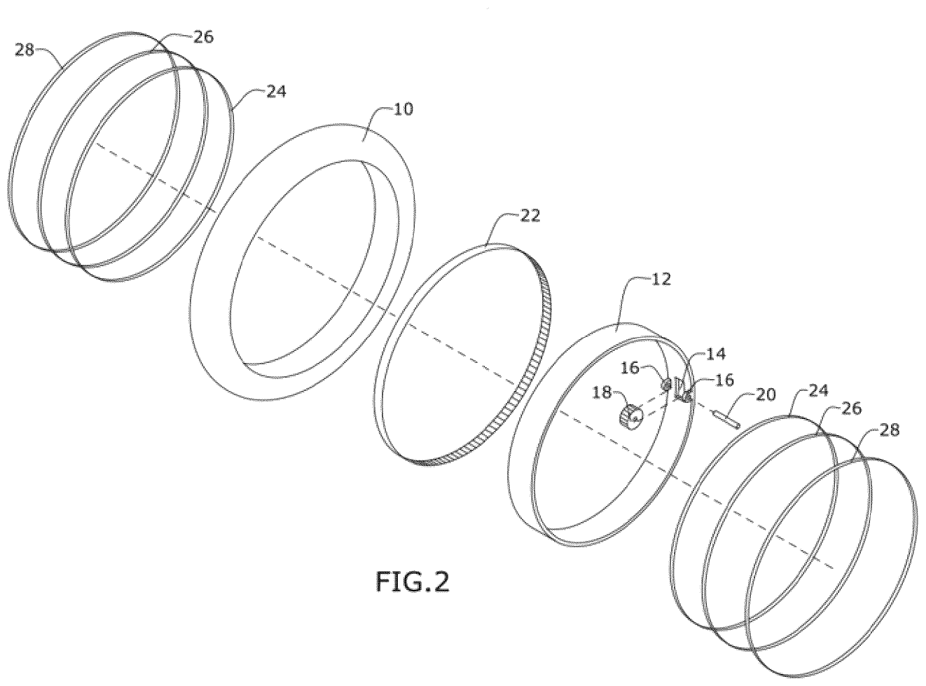

The outer ring 14 can connect to or include a geared ring 22, as shown in FIG. 2. The geared ring 22 can include teeth that can accept and engage with another gear. The geared ring 22 can drive the rotation of the outer ring 14 when another gear transmits rotational movement via torque and speed to the geared ring 22. Because the outer ring 14 connects to the geared ring 22, rotational movement of the geared ring 22 also causes rotational movement of the outer ring 14.

The inner ring 12 can further comprise a dual flange 16 formed on each side of the inner ring 12. The dual flange 16 can include holes for receiving and holding an axle 20. The axle 20 can extend across the dual flange 16 such that the axle 20 is held within each hole of the dual flange 16. In some embodiments, the axle 20 can act as a shaft for a motor 18. The motor 18 can extend through a hole 14 in the inner ring 12, and the motor 18 can engage the geared ring 22 through the hole 14. The motor 18 also can include gear teeth that engage and mesh with the geared ring 22. As a result, when the motor 18 turns, the gears of the motor 18 may engage with the geared ring 22, thereby causing the outer ring 10 to turn. The motor 18 can drive the safety and stability device 100 to very fast speeds and a high rotation per minute (RPM). With enough rotational speed, the safety and stability device 100 can generate gyroscopic stability for the safety and stability device 100 and any aircraft component formed inside the inner ring 12, such as a drone or a personal aircraft. Additionally, the safety and stability device 100 can act as a wing for the aircraft when rotated at a given speed.

The rotation speed of the safety and stability device 100 can vary depending on the translational speed of the aircraft. For example, at higher translational speeds, the rotational speed of the safety and stability device 100 can increase, whereas at lower translational speeds, the rotational speed of the safety and stability device 100 can decrease. The increased rotational speed at higher translational speed encourages stability of the aircraft. In some embodiments, the rotational speed of the safety and stability device 100 can have a direct relationship with the aircraft's translational speed. In another embodiment, the rotational speed of the safety and stability device 100 can have an exponential relationship with the aircraft's translational speed.

More accurately, the rotational speed of the safety and stability device 100 can vary depending on sensor readings that assist in keeping the aircraft fuselage straight and stable during flight. For example, the aircraft may include one or multiple gyroscope sensors to determine whether the aircraft is stable during flight. A processor can receive measurements from the gyroscope sensors, and the processor can adjust the rotational speed of the safety and security device 100 to balance the aircraft fuselage. It should be noted that rotating the safety and security device 100 changes the weight ratio of the entire aircraft. Those having skill in the art will know that flight requires a balance of both lift and aircraft weight as well as balancing thrust and drag. Because changes in rotational speed of the safety and security device 100 can change the weight ratio, then the amount of lift required for flight also changes and the aircraft may stabilize in view of the change in rotational speed by the safety and security device 100. The processor is programmed with various formulas and software to control the rotational speed of the safety and security device 100 in response to gyroscope sensor readings, thereby stabilizing the aircraft for flight.

Additionally, those skilled in the art with recognize that aircrafts having spinning objects for flight have “left-turning tendency”, and the processor is further programmed to combat this known phenomenon. In any embodiment, the processor can control the rotational speed of the safety and stability device 100, and the safety and stability device 100 may comprise the processor. The processor can receive or measure the translational speed of the aircraft, and the processor can apply any formulas by referencing the formula or other relationship programmed into computer-readable memory, and the processor can further send signals to the motor 18 to increase or decrease the rotational speed of the safety and stability device 100 based on the gyroscope readings.

Rotating the safety and security device 100 can have additional benefits other than stability and safety. During translational movement, the nose of an airplane typically increases in heat due to an increase in translational speed due to air drag. The same would be true of the aircrafts disclosed herein, but because the forward most point of the aircrafts disclosed herein is the safety and security device 100, which rotates, the rotation of the safety and security device 100 can dissipate the generated heat across the entire safety and security device 100. This dissipation can decrease the heat load on the aircraft and also decrease the need for heat plates at a nose or front tip of an aircraft.

During takeoff, the safety and security device 100 can apply disk loading principals, by slowing ramping up the rotational movement of the safety and security device 100 to a stable rotational speed (e.g., 2500 RPM). The rotation of the safety and security device 100 can provide some lift, but not enough for takeoff or extended flight, so the aircrafts disclosed herein may have additional propellers or the like to provide extended flight. Additional propellers are particularly necessary for takeoff, which lifts dead weight even though the weight ratio of the aircraft changes due to the rotation of the safety and security device 100.

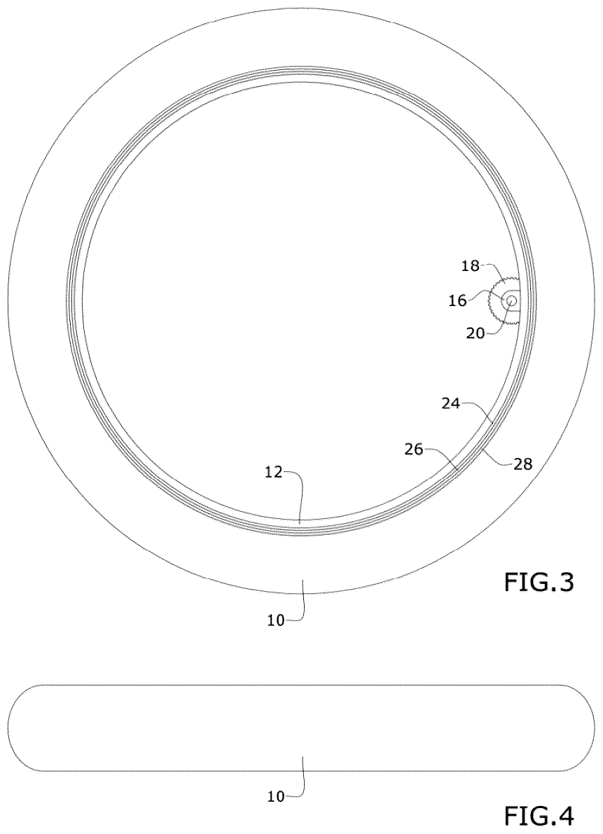

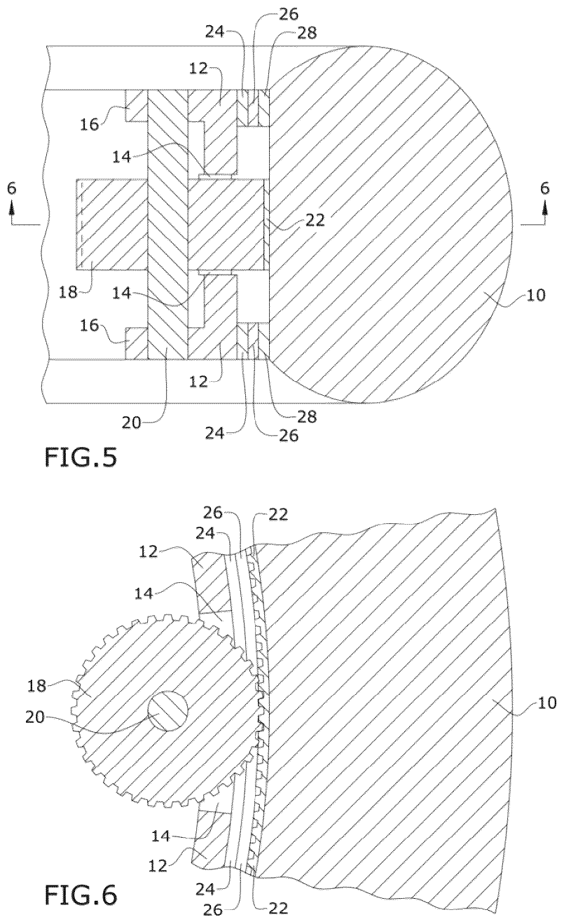

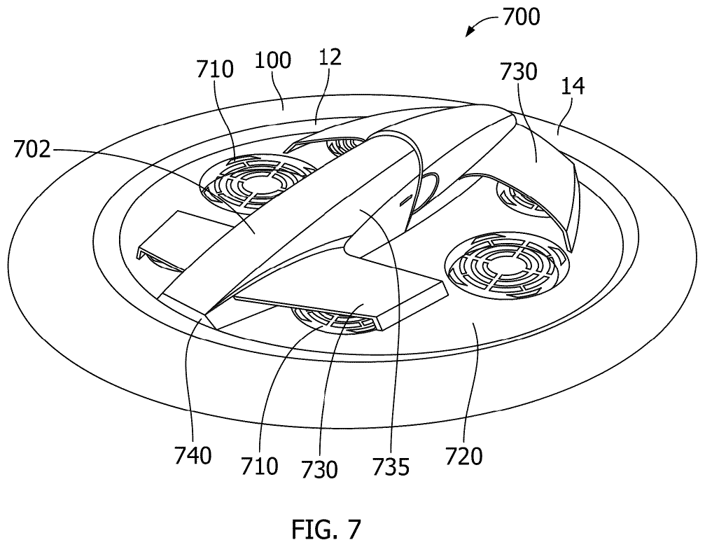

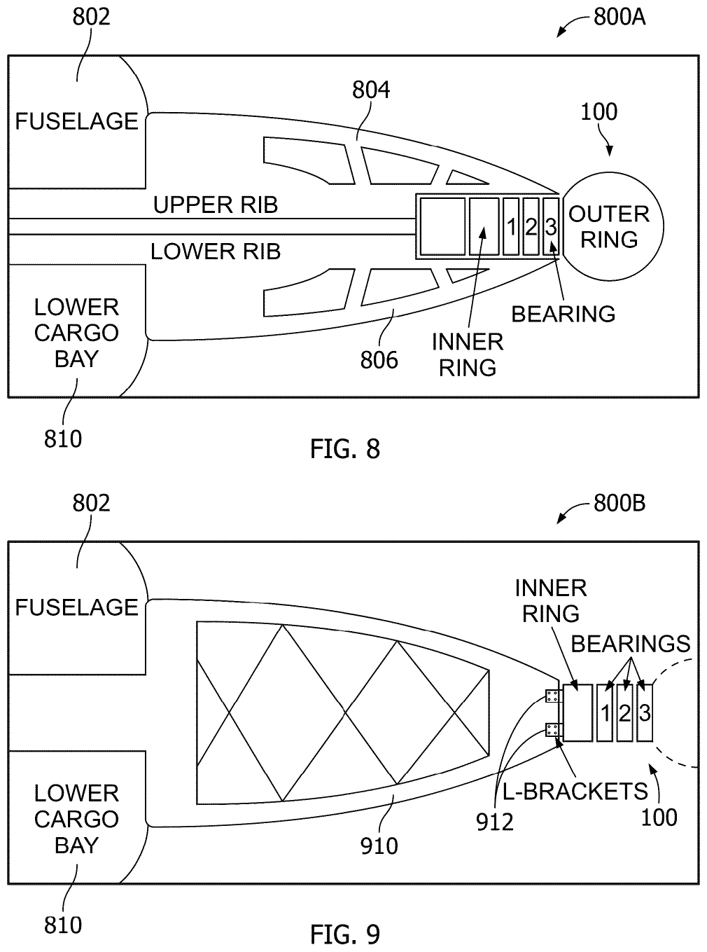

FIG. 3 illustrates the safety and stability device 100 from a side perspective, and FIG. 4 illustrates the safety and stability device from a top perspective. In some embodiments, the outer ring 10 may comprise a soft material such as rubber and may be filled with air, similar to a tire. Alternatively, the outer ring 10 may comprise any material that softens impact of the outer ring 14 with any solid structure that it strikes, and such material may comprise an air-filled polymer, polyethene foam, gels or any other soft material that reduces the impact of any forceful strike with a solid object. FIG. 5 illustrates the safety and stability device 100 at the cross section illustrated by line 5-5 in FIG. 1, and FIG. 6 illustrates the safety and stability device 100 at the cross section illustrated by line 6-6 in FIG. 5. FIGS. 5 and 6 better illustrate the interaction between the geared motor 18 and the geared ring 22 that causes rotation of the outer ring 14.

Importantly, the safety and stability device 100 rotates in a substantially horizontal plane. Because the safety and stability device 100 rotates horizontally, the safety and stability device 100 provides gyroscopic stability that stabilizes the safety and stability device 100 and anything connected to the safety and stability device 100 within the circular area created by the inner ring 12. Moreover, the horizonal rotation of the safety and stability device 100 provides protection of the aircraft fuselage at all sides of the aircraft. That is, the safety and stability device can protect the aircraft should the aircraft strike any structure during translational movement.

Notably, the safety and stability device 100 lacks a hub within the circular inner area created by the inner ring 12. The safety and stability device 100 lacks a hub so that additional aviation equipment may exist within and connect to the safety and stability device 100. The additional aviation equipment can include any aviation equipment including drone equipment, a cockpit, a fuselage, a passenger cabin, a cargo compartment, jet engines, flaps, motors, propellers, canards, or any other equipment used in aviation.

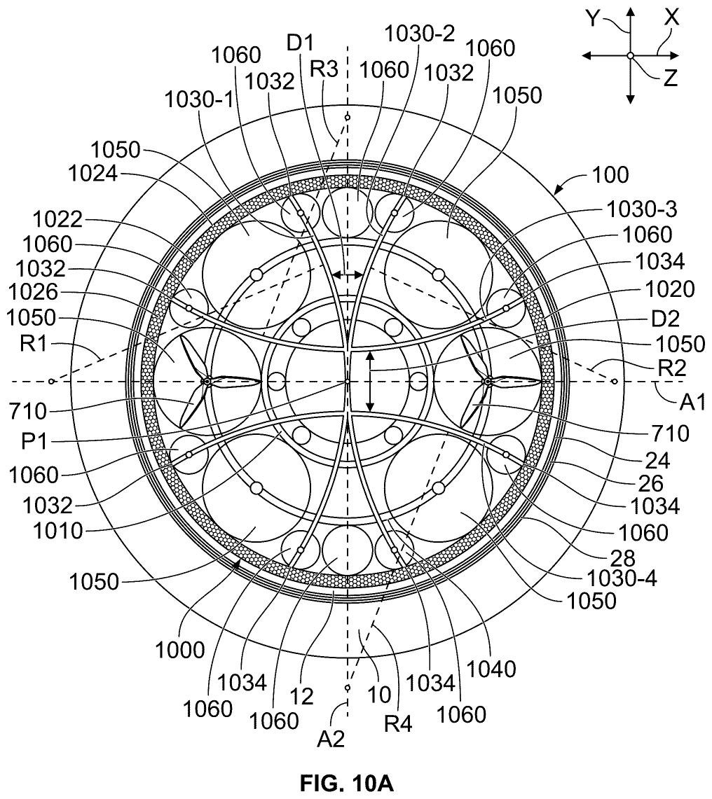

FIG. 7 illustrates an aircraft embodiment 700 implementing the safety and stability device 100 described above with reference to FIGS. 1-6. As shown in FIG. 7, the aircraft 702 fits within the hole created by the inner ring 12 (because the safety and stability device 100 lacks a hub). Moreover, the outer ring 14 rotates around the aircraft 702. In one embodiment, the aircraft 702 can include multiple propellers 710 all formed within the inner ring 12 of the safety and stability device 100. The number of propellers 710 can vary, with FIG. 7 illustrating a six-propeller embodiment, but other embodiments may have a single propeller, two propellers, four propellers, or any number of propellers. Each propeller may be associated with a respective motor driving the propeller. Additionally, the propellers 710 may increase rotation speed to increase the altitude of the drone embodiment 700, and the propellers 710 may decrease rotation speed to decrease the altitude of the drone embodiment 700. Also, in an embodiment, where the propellers 710 are used to turn the drone embodiment 700, the clockwise turning propellers may decrease in speed while the counterclockwise spinning propellers increase in speed 700 to turn the drone 700 to the left, whereas the counterclockwise propellers may decrease in speed while the clockwise propellers increase in speed 700 to turn the drone 700 to the right. In another embodiment, flaps on the wings or tailfin in conjunction with aircraft tilt may cause the drone embodiment 700 to turn left or right. In some embodiments, the aircraft 702 can comprise a drone, while in another embodiment, the aircraft 702 can comprise a human-piloted aircraft or an aircraft that carries and flies humans as a mode of transportation.

The aircraft 702 can further include a top disc 720 and a bottom disk (not shown), where the top and bottom disks 720 can have a radius substantially similar to the radius of the inner ring 12. In this way, the aircraft 702 can connect to the inner ring 12 of the safety and stability device 100. In some embodiments, the top and bottom disks 720 can be welded to the inner ring 12 or together form the inner ring 12, but other connection methods are contemplated, such as a removable and replaceable option to swap out one aircraft 702 for another. The propellers 710 can spin between the top and bottom disks 720, and the top and bottom disks 720 may include grills placed above and below each propeller 710.

Referring again to FIG. 7, the aircraft 702 can include a canard 730 acting as additional wings for flight control of the drone embodiment 700. As shown, the canard 730 can include a combination of front and rear wings, as is well-understood in the art of aviation. The canard 730 can connect to and extend outward from a main body 735, which can house important internal components, such as a fuel tank, a battery, a main computer, propeller motors, wireless connection with a control unit operated by a human to fly the drone, or any other internal component, as would be well-understood in the field of drone aviation.

In the embodiment shown in FIG. 7, flight can be controlled by the combination of the plurality of propellers 710, the canard 730, the safety and stability device 100, and propulsion engines 740. In this embodiment, the propulsion engines 740 can generate translational or forward movement of the aircraft, the plurality of propellers 710 can primarily provide the upward lift of the drone embodiment 700, the canard 730 can provide lift, control, and stability for the drone embodiment 700, and the safety and stability device 100 can provide stability, some lift, and aerodynamic benefits by cutting through the air at a high rate of speed, thereby decreasing the drag on the aircraft 702. In some embodiments, the propellers 710 may provide lift only until the canard 730 and the safety and stability device 100 are able to maintain lift alone, which may occur at high translational speeds resulting from propulsion provided by the propulsion engine 740, at which time the propellers may stop spinning at a high rate of speed. In some embodiments, the propulsion engines 740 may be omitted in favor of a drone embodiment 700 where the propellers 710 provide translational movement and lift. In yet another embodiment, the canard 730 and/or the propulsion engines 740 may be omitted. In other words, any drone configuration capable of connection to the safety and stability device 100 is envisioned.

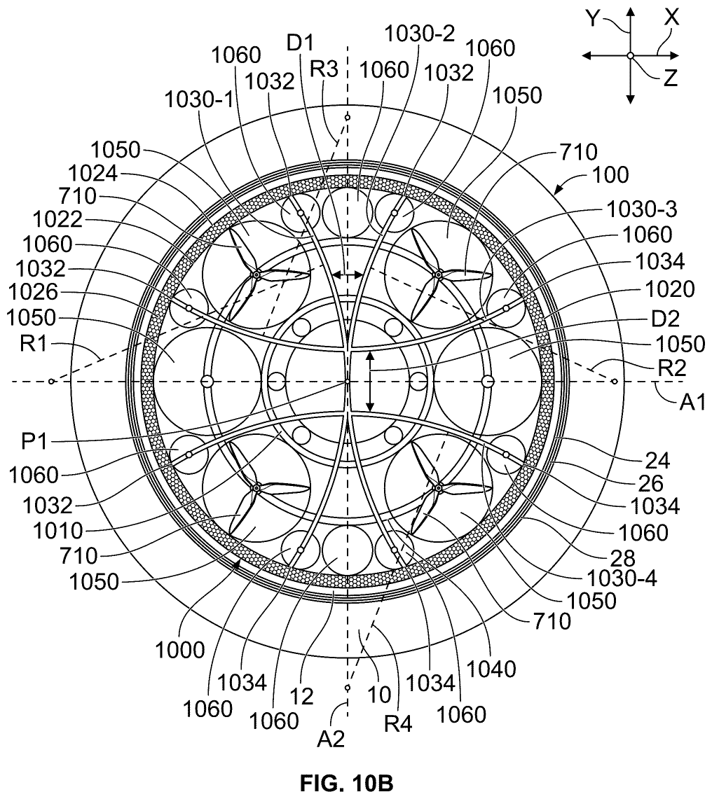

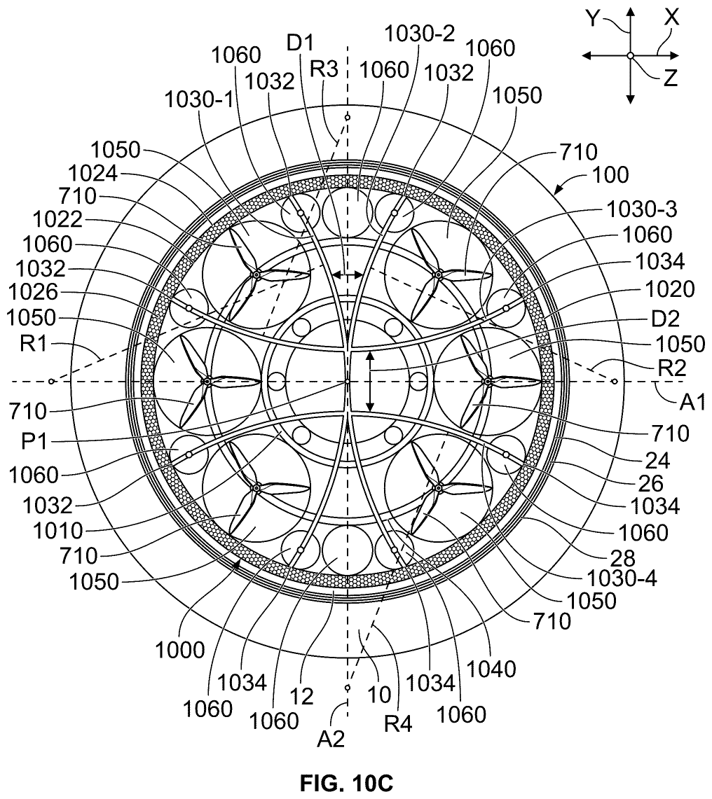

Referring now to FIGS. 8-9, FIGS. 8-9 illustrate a personal aircraft embodiment 800 configured for use with the safety and stability device 100. More particularly, FIGS. 8-9 illustrate components for connecting a fuselage and other compartments to the safety and stability device 100. In some embodiments, the personal aircraft embodiment 800 may operate similar to a personal helicopter for providing relatively short distance air travel. In this way, the personal aircraft embodiment 800 may include a main propeller and tail rotor for control, turning, and reactional torque to prevent spinning of the personal aircraft embodiment 800. The main propeller and rear rotor are not illustrated, as those features would be well-understood by those of skill in the art.

FIG. 8 illustrates a first personal aircraft embodiment 800A, where the safety and stability device 100 connects to a fuselage 802 via an upper rib 804 and a lower rib 806. FIG. 8 illustrates a cross-section of one upper rib 804 and one lower rib 806, but the first personal aircraft embodiment 800A may include multiple upper ribs 804 and multiple lower ribs 806 placed evenly around the safety and stability device 100. That is, the ribs 804, 806 may surround or encircle the fuselage 802 and connect to multiple points of the circular safety and security device 100. As shown in FIG. 8, the upper rib 804 and the lower rib 806 connect to the inner ring 12 and also surround the plurality of bearings 24, 26, 28, and the upper rib 804 and the lower rib 806 can also connect to the fuselage 802 and a lower cargo bay 810. In some embodiments, the fuselage may comprise a cockpit of the personal aircraft embodiment 800 where a human operator may sit and fly the personal aircraft embodiment 800. The upper rib 804 and the lower rib 806 may include holes for aerodynamic purposes to reduce drag during translational movement of the first personal aircraft embodiment 800A.

FIG. 9 illustrates a second personal aircraft embodiment 800B, where the safety and stability device 100 connects to a fuselage 802 via brackets 910. FIG. 9 illustrates a cross-section of one bracket 910, but the second personal aircraft embodiment 800B may include multiple brackets 910 placed evenly around the safety and stability device 100. That is, the brackets 910 may surround or encircle the fuselage 802 and connect to multiple points of the circular safety and security device 100. As shown in FIG. 9, the bracket 910 connects to the inner ring 12 and the fuselage 802 and a lower cargo bay 810. The bracket 910 may include a hole for aerodynamic purposes to reduce drag during translational movement of the personal aircraft embodiment, but the hole may further include cross bracing to increase the strength of the bracket 910. Additionally, the bracket 910 can include one or more L-brackets 912 that connect the inner ring 12 of the safety and stability device 100 to the bracket 910. While L-Brackets are shown in the embodiment shown in FIG. 9, any other connection mechanism are contemplated.

In either embodiment illustrated in FIGS. 8-9, the fuselage 802 may disconnect easily from the brackets 910 or the upper and lower ribs 804, 806 in the event of an emergency. By disconnecting the fuselage 802, the fuselage 802 may eject or fall from the rest of the aircraft, and the fuselage 802 may include a parachute to allow a safe landing of the fuselage 802.

Although the embodiments described in FIGS. 8-9 describe a personal aircraft, the embodiments described herein can increase in size by increasing the circumference of the safety and stability device 100 to allow for additional passengers. The exemplary embodiments described herein are not limited to a single seater aircraft.

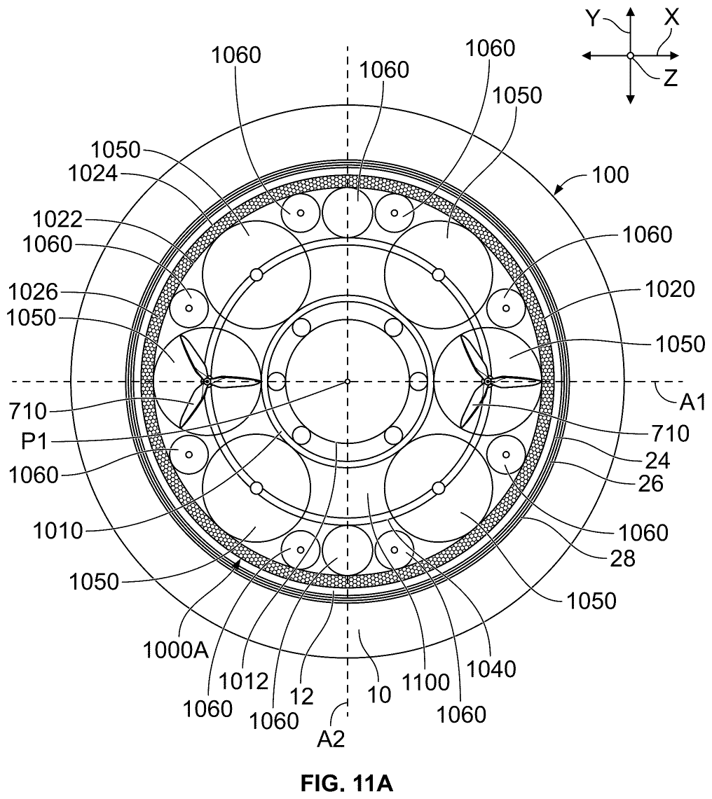

As shown in FIGS. 10A, 10B, and 10C, in various implementations, the personal aircraft embodiment 800 includes a frame 1000. The frame 1000 may be disposed within the safety and stability device 100. For example, the frame 1000 may be disposed within and connected to the inner ring 12 of the safety and stability device 100. The fuselage 802 may be disposed on top of and connected to the frame 1000. In various implementations, the frame 1000 provides support for the personal aircraft embodiment 800 or portions of the personal aircraft embodiment 800, such as the fuselage 802, while being lightweight and flexible to aid in absorbing any impacts the personal aircraft embodiment 800 experiences. In various implementations, the frame 1000 or one or more components thereof include carbon fiber. In various implementations, the frame 1000 is a non-pneumatic structure.

The frame 1000 may include a circular inner frame member 1010, a circular outer frame member 1020, and one or more connecting members 1030. In various implementations, the one or more connecting members 1030 may include a first connecting member 1030-1, a second connecting member 1030-2, a third connecting member 1030-3, and a fourth connecting member 1030-4. The circular inner frame member 1010 and the circular outer frame member 1020 may be disposed around a center point Pl on the frame 1000. The circular outer frame member 1020 may surround the circular inner frame member 1010. In this regard, the circular inner frame member 1010 may define a first radius and the circular outer frame member 1020 may define a second radius, which is larger than the first radius.

In various implementations, the frame 1000 may include a circular intermediate frame member 1040 disposed around the center point PI between the circular inner frame member 1010 and the circular outer frame member 1020. In this regard, the circular intermediate frame member 1040 may define a third radius that is larger than the first radius but smaller than the second radius. In various implementations, the circular inner frame member 1010, the circular outer frame member 1020, and/or the circular intermediate frame member 1040 are concentrically disposed around one another.

Each of the one more connecting members 1030 may connect to the circular inner frame member 1010 and the circular outer frame member 1020. In various implementations, each of the one or more connecting members 1030 may connect to the circular outer frame member 1020 at a first end 1032 and a second end 1034 of the connecting member 1030, and each of the one or more connecting members 1030 may connect to the circular inner frame member 1010 at two points between the first end 1032 and the second end 1034 of the connecting member 1030. In various implementations, each of the one or more connecting members may further connect to the circular intermediate frame member 1040 at two points between the first end 1032 and the second end 1034 of the connecting member 1030.

Each of the one or more connecting members 1030 may have a generally arcuate shape. Each of the one or more connecting members 1030 may define a radius of curvature. In various implementations, the first, second, third, and fourth connecting members 1030-1, 1030-2, 1030-3, 1030-4 may define first, second, third, and fourth radii of curvature R1, R2, R3, R4. Each of the radii of curvature R1, R2, R3, R4 may be the same or different from each of the other radii of curvature R1, R2, R3, R4. In various implementations, the first radius of curvature R1 may be equal to the second radius of curvature R2, In various implementations, the third radius of curvature R3 may be equal to the fourth radius of curvature R4. In various implementations, all the radii of curvature R1, R2, R3, R4 may be the same.

In various implementations, the first connecting member 1030-1 and the second connecting member 1030-2 may extend substantially in a first direction (e.g., Y-direction), while the third connecting member 1030-3 and the fourth connecting member 1030-4 may extend substantially in a second direction (e.g., X-direction).

In various implementations, the first connecting member 1030-1 and the second connecting member 1030-2 may define a first distance DI therebetween. The first distance DI may be at a minimum where the first and second connecting members 1030-1, 1030-2 are closest to the center point P1 and increase, in either direction, as the first and second connecting members 1030-1, 1030-2 extend towards the circular outer frame member 1020. In various implementations, one or both of the first and second connecting members 1030-1, 1030-2 may pass through the center point P1. In various implementations, the first and second connecting members 1030-1, 1030-2 may be connected to one another at the center point P1.

In various implementations, the third connecting member 1030-3 and the fourth connecting member 1030-4 may define a second distance D2 therebetween. The second distance D2 may be at a minimum where the third and fourth connecting members 1030-3, 1030-4 are closest to the center point Pl and increase, in either direction, as the third and fourth connecting members 1030-3, 1030-4 extend towards the circular outer frame member 1020. In various implementations, the third connecting member 1030-3 may connect to one or both of the first and second connecting members 1030-1, 1030-2. In various implementations, the fourth connecting member 1030-4 may connect to one or both of the first and second connecting members 1030-1, 1030-2. In various implementations, the third connecting member 1030-3 may not connect to the fourth connecting member 1030-4.

Each of the one or more connecting members 1030 may be flexible thereby allowing the frame 1000 to at least partially absorb or dissipate any forces imparted on the personal aircraft embodiment 800 (e.g., by an object colliding with the personal aircraft embodiment 800 or the personal aircraft embodiment 800 colliding with an object). In various implementations, each of the one or more connecting members 1030 may flex (e.g., bend) towards the center point P1.

In various implementations, the circular outer frame member 1020 may include an inner surface 1022, an outer surface 1024 that surrounds the inner surface 1022, and an energy absorbing member 1026 disposed between the inner surface 1022 and the outer surface 1024. In various implementations, the energy absorbing member 1026 may be flexible thereby allowing the frame 1000 to at least partially absorb or dissipate any forces imparted on the personal aircraft embodiment 800 (e.g., by an object colliding with the personal aircraft embodiment 800 or the personal aircraft embodiment 800 colliding with an object). In this regard, the energy absorbing member 1026 may allow the outer surface 1024 to flex towards the inner surface 1022 in response to a force imparted on the personal aircraft embodiment 800. In various implementations, the energy absorbing member 1026 may be a honeycomb-shaped structure connected to the inner surface 1022 and the outer surface 1024. In other words, the energy absorbing member 1026 may define a plurality of hexagon-shaped openings. In various implementations, the circular outer frame member 1020 may be made out of carbon fiber, rubber, or any other suitable material that can provide the necessary blend of flexibility and rigidity.

In various implementations, the frame 1000 may include a plurality of housings 1050 that hold the plurality of propellers 710. In various implementations, the plurality of housings 1050 may include six housings. In various implementations, the plurality of propellers 710 may include two propellers (FIG. 10A), four propellers (FIG. 10B), or six propellers (FIG. 10C). The plurality of propellers 710 may also include any other number of propellers within the scope of the present disclosure. In various implementations, when the number of propellers 710 is less than the number of housings 1050, the extra housings may still present on the frame 1000 but may be empty. In various implementations, the plurality of propellers 710 may be disposed between the circular outer frame member 1020 and the circular inner frame member 1010. In various implementations, each of the plurality of propellers 710 may be attached to the circular intermediate frame member 1040. The plurality of propellers may also connect to motors, which may connect to the circular intermediate frame member 1040.

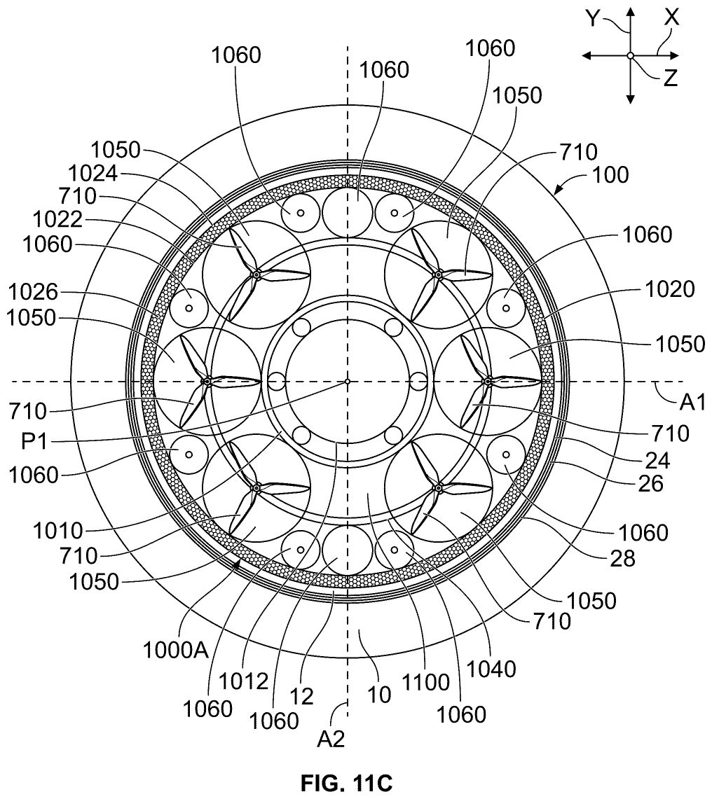

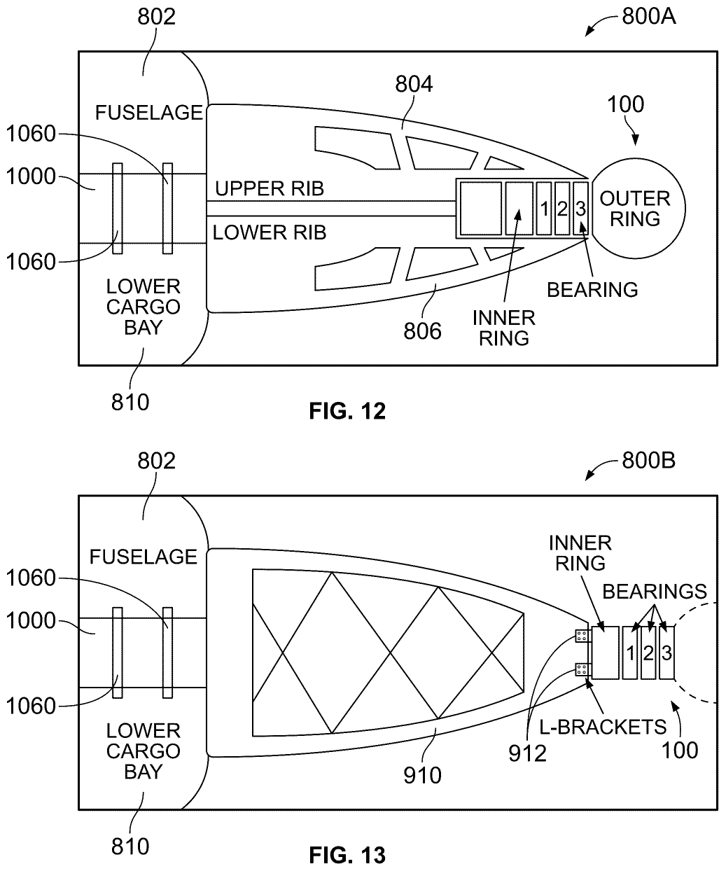

In various implementations, the frame 1000 may include one or more tubes 1060 extending through the frame 1000. As shown in FIGS. 12 and 13, the one or more tubes 1060 may allow one or more components of the personal aircraft embodiment 800 (or the aircraft embodiment 700), such as the fuselage 802 and/or the lower cargo bay 810 to connect to the frame 1000. The one or more tubes 1060 may provide a strong and lightweight method of connecting the fuselage 802 and/or the lower cargo bay 810 to the frame 1000. The one or more tubes 1060 may connect to various other components of the frame 1000, such as the circular inner frame member 1010, the circular outer frame member 1020, any or all of the one or more connecting members 1030, the circular intermediate frame member 1040, and/or one or more of the plurality of housings 1050. In various implementations, the one or more tubes 1060 may be thin-walled hollow tubes made of carbon fiber.

In various implementations, the frame 1000 may be symmetric about a first axis A1 and/or a second axis A2. In various implementations, the first axis A1 may be orthogonal to the second axis A2.

While the frame 1000 is described above as part of the personal aircraft embodiment 800, it will be understood that the frame 1000 may also be a part of the aircraft embodiment 700 within the scope of the present disclosure. The frame 1000 may also be used in other applications outside of aviation, including automobiles or any other moving vehicle.

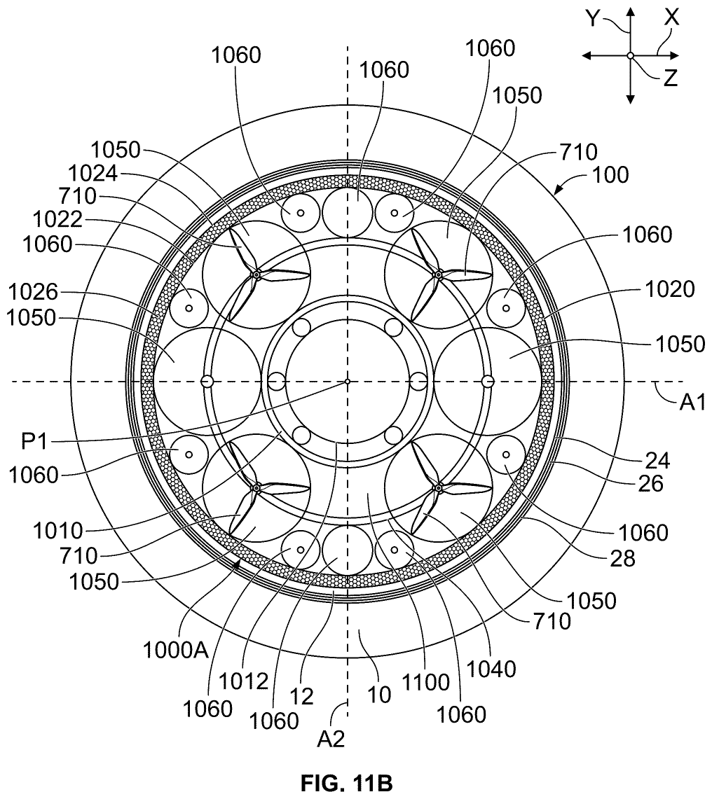

FIGS. 11A, 11B, and 11C illustrate another frame 1000a for the personal aircraft embodiment 800 according to an exemplary embodiment. The frame 1000a may be disposed within the safety and stability device 100. For example, the frame 1000a may be disposed within and connected to the inner ring 12 of the safety and stability device 100. The fuselage 802 may be disposed on top of and connected to the frame 1000a. In various implementations, the frame 1000a may provide support for the personal aircraft embodiment 800 or portions of the personal aircraft embodiment 800, such as the fuselage 802, while being lightweight and flexible to aid in absorbing any impacts the personal aircraft embodiment 800 experiences. In various implementations, the frame 1000a or one or more components thereof may include carbon fiber. In various implementations, the frame 1000a may be a non-pneumatic structure. Just like the frame 1000, in various implementations, the frame 1000a can include two propellers (FIG. 11A), four propellers (FIG. 11B), or six propellers (FIG. 11C). The frame 1000a may also include any other number of propellers within the scope of the present disclosure. In view of the substantial similarity in structure and function of the components associated with the frame 1000a relative to the frame 1000, like reference numerals are used hereinafter and, in the drawings, to identify like components while like reference numerals containing letter extensions (e.g., “a”) are used to identify those components that have been modified.

The frame 1000a may include the circular inner frame member 1010, the circular outer frame member 1020, the circular intermediate frame member 1040, the plurality of housings 1050, the one or more tubes 1060, and the plurality of propellers 710. However, the frame 1000a may omit the one or more connecting members 1030. Instead, in the frame 1000a, the one or more connecting members 1030 may be replaced by a sheet material 1100 that serves a substantially similar purpose and function to the one or more connecting members 1030.

In various implementations, the sheet material 1100 may extend from an inner surface 1012 of the circular inner frame member 1010 to the inner surface 1022 of the circular outer frame member 1020. In various implementations, the sheet material 1100 may connect the components (e.g., the circular inner frame member 1010, the circular outer frame member 1020, the circular intermediate frame member 1040, the plurality of housings 1050, the one or more tubes 1060, and the plurality of propellers 710) of the frame 1000a to one another. In various implementations, the plurality of housings 1050 and/or the one or more tubes 1060 may be disposed in openings cut in the sheet material 1100. In various implementations, the one or more tubes 1060 may extend through the openings in the sheet material 1100. In various implementations, the sheet material 1100 may include carbon fiber. In various implementations, the sheet material 1100 may be approximately two millimeters thick. In various implementations, the sheet material may provide the necessary blend of flexibility and rigidity to the frame 1000a.

FIG. 12 illustrates the first personal aircraft embodiment 800A, where the frame 1000, 1000a is disposed between the fuselage 802 and the lower cargo bay 810. Like the fuselage 802, the frame 1000, 1000a may connect to the safety and stability device 100 via the upper rib 804 and the lower rib 806. The ribs 804, 806 may surround or encircle the frame 1000, 1000a and connect to multiple points of the circular safety and security device 100. The ribs 804, 806 may connect to the inner ring 12 and the fuselage 802 and the frame 1000, 1000a, and the lower cargo bay 810.

FIG. 13 illustrates the first personal aircraft embodiment 800A, where the frame 1000, 1000a is disposed between the fuselage 802 and the lower cargo bay 810. Like the fuselage 802, the frame 1000, 1000a may connect to the safety and stability device 100 via brackets 910. The brackets 910 may surround or encircle the frame 1000, 1000a and connect to multiple points of the circular safety and security device 100. The bracket 910 connects to the inner ring 12 and the fuselage 802 and the frame 1000, 1000a, and the lower cargo bay 810. Additionally, the bracket 910 can include one or more L-brackets 912 that connect the inner ring 12 of the safety and stability device 100 to the bracket 910. While L-Brackets are shown in the embodiment shown in FIG. 13, any other connection mechanism are contemplated.

As has been shown, the exemplary embodiments described herein illustrate an aircraft having a safety and stability device that surrounds an aircraft's fuselage for protection of the aircraft and stability of the aircraft. An aircraft having a rotating with can provide increased stability and protection, which may lower the learning curve necessary for more people to use air travel to travel shorter distances typically only available by automobile, bicycle, or other short-distance travel options. Therefore, the aircraft having the rotational wing described herein represents a dramatic improvement over the prior art.

Although a few embodiments have been described in detail above, other modifications are possible. For example, other components may be added to or removed from the described systems, and other embodiments may be within the scope of the invention.

From the foregoing, it will be observed that numerous variations and modifications may be effected without departing from the spirit and scope of the invention. It is to be understood that no limitation with respect to the specific system or method described herein is intended or should be inferred. It is, of course, intended to cover all such modifications as fall within the spirit and scope of the invention.

1. A frame for an aircraft comprising:
a circular inner frame member disposed around a center point;
a circular outer frame member disposed around the center point and surrounding the circular inner frame member;
a first connecting member configured to connect the circular inner frame member to the circular outer frame member; and
a second connecting member configured to connect the circular inner frame member to the circular outer frame member, wherein:
the first connecting member and the second connecting member define a first distance therebetween, and
the first distance increases in a first direction extending from the center point towards the circular outer frame member.

2. The frame of claim 1 wherein:
the first connecting member defines a first radius of curvature,
the second connecting member defines a second radius of curvature, and
the first radius of curvature is equal to the second radius of curvature.

3. The frame of claim 1 wherein the first connecting member and the second connecting member pass through the center point.

4. The frame of claim 1 wherein the first connecting member is connected to the second connecting member at the center point.

5. The frame of claim 1 further comprising:
a third connecting member configured to connect the circular inner frame member to the circular outer frame member; and
a fourth connecting member configured to connect the circular inner frame member to the circular outer frame member, wherein:
the third connecting member and the fourth connecting member define a second distance therebetween, and
the second distance increases in a second direction extending from the center point towards the circular outer frame member.

6. The frame of claim 5 wherein the second direction is transverse to the first direction.

7. The frame of claim 5 wherein the third connecting member is connected to the first connecting member and the second connecting member.

8. The frame of claim 7 wherein the fourth connecting member is connected to the first connecting member and the second connecting member.

9. The frame of claim 5 wherein the third connecting member is not connected to the fourth connecting member.

10. The frame of claim 5 wherein:
the third connecting member defines a third radius of curvature,
the fourth connecting member defines a fourth radius of curvature, and
the third radius of curvature is equal to the fourth radius of curvature.

11. The frame of claim 1 wherein the circular outer frame member includes:
an inner surface,
an outer surface surrounding the inner surface, and
an energy absorbing member disposed between the inner surface and the outer surface and configured to allow the outer surface to flex relative to the inner surface in response to a force being imparted on the aircraft.

12. The frame of claim 11 wherein the energy absorbing member defines a honeycomb-shaped structure connecting the inner surface to the outer surface.

13. The frame of claim 1 further comprising one or more propellers disposed between the circular outer frame member and the circular inner frame member.

14. The frame of claim 13 further comprising a circular intermediate frame member disposed between the circular inner frame member and the circular outer frame member.

15. The frame of claim 14 wherein the one or more propellers are connected to the circular intermediate frame member.

16. The frame of claim 1 further comprising one or more tubes extending through the frame and configured to allow airflow through the frame.

17. An aircraft comprising:
a safety and stability device including:
an inner ring,
an outer ring that rotates relative to the inner ring,
a motor connected to the inner ring that drives rotation of the outer ring relative to the inner ring, and
a geared ring connected to the outer ring, wherein the safety and stability device rotates in a substantially horizontal plane and at a rotational speed sufficient to provide gyroscopic stability for the aircraft; and
the frame of claim 1, wherein the frame is disposed within the inner ring.

18. The aircraft of claim 17 further comprising a fuselage disposed above the frame.

19. A frame for an aircraft comprising:
a circular inner frame member;
a circular outer frame member concentrically disposed around and surrounding the circular inner frame member; and
a sheet material extending between and connecting the circular inner frame member to the circular outer frame member.

20. The frame of claim 19, wherein the circular outer frame member comprises:
an inner surface,
an outer surface surrounding the inner surface, and
an energy absorbing member disposed between the inner surface and the outer surface and configured to allow the outer surface to flex relative to the inner surface in response to a force being imparted on the aircraft.

21. The frame of claim 20 wherein the energy absorbing member defines a honeycomb-shaped structure connecting the inner surface to the outer surface.

22. The frame of claim 19 further comprising one or more propellers disposed between the circular outer frame member and the circular inner frame member.

23. The frame of claim 22 further comprising a circular intermediate frame member disposed between the circular outer frame member and the circular inner frame member, wherein the one or more propellers are connected to the circular intermediate frame member.

24. The frame of claim 22 further comprising a plurality of housings, wherein each of the one or more propellers are disposed within a corresponding housing of the plurality of housings.

25. The frame of claim 24 wherein:
the sheet material includes a plurality of openings, and
each of the plurality of housings are disposed within a corresponding opening of the plurality of openings.

26. The frame of claim 19 further comprising one or more tubes extending through the sheet material.

27. The frame of claim 26 wherein:
the sheet material includes a plurality of openings, and
each of the one or more tubes extends through a corresponding opening of the plurality of openings.

28. The frame of claim 19 wherein the sheet material extends from an inner surface of the circular inner frame member to an inner surface of the circular outer frame member.

29. An aircraft comprising:
a safety and stability device including:
an inner ring,
an outer ring that rotates relative to the inner ring,
a motor connected to the inner ring that drives rotation of the outer ring relative to the inner ring, and
a geared ring connected to the outer ring, wherein the safety and stability device rotates in a substantially horizontal plane and at a rotational speed sufficient to provide gyroscopic stability for the aircraft; and
the frame of claim 21, wherein the frame is disposed within the inner ring.

30. The aircraft of claim 29 further comprising a fuselage disposed above the frame.

31. The aircraft of claim 30 further comprising a lower cargo bay disposed below the frame.

32. The aircraft of claim 31 wherein:
the frame includes one or more tubes extending through the sheet material, and
the one or more tubes are configured to connect the frame to at least one of: the fuselage or the lower cargo bay.
